(19) United States
(12) Patent Application Publication
(10) Pub. No.: US 2017/0042307 A1
(43) Pub. Date: Feb. 16, 2017

(54) Combination Nail Care Tool

(71) Applicant: Tyler Blunt, Fountain Hills, AZ (US)

(72) Inventor: Tyler Blunt, Fountain Hills, AZ (US)

(21) Appl. No.: 15/306,597

(22) PCT Filed: Apr. 25, 2014
(86) PCT No.: PCT/US14/35540

§ 371 Date: Oct. 25, 2016

(51) Int. Cl. A45D 29/18; B25F 1/04; A45D 26/00; A45D 29/02; A45D 29/04; A45D 29/16; B26B 13/22; B25F 1/00

(52) U.S. Cl. CPC A45D 29/18; B26B 13/22; B25F 1/04; B25F 1/003; A45D 29/02; A45D 29/04; A45D 29/16; A45D 26/0066

(57) ABSTRACT

A combination nail care tool is disclosed. The combination tool can include a plurality of different tools such as nail clippers, cuticle scissors, tweezers, a cuticle pusher, cuticle nippers, and a file. The tools may be integrated into a small and aesthetically pleasing housing that can improve grip and provide ready access to a particular tool as well as a safe and convenient means for storage or transport.

### CROSS-REFERENCE TO RELATED APPLICATIONS

This application claims the benefit of U.S. Provisional Application No. 61/816,669, filed Apr. 26, 2013.

### BACKGROUND

Technical Field

This invention relates generally to a combination tool and system, and to methods of use thereof and, more particularly, to a combination nail care or pedicure tool having a foldable housing.

State of the Art

A manicure is a treatment to improve the appearance and health of the hands and fingernails. The treatment can include cutting, shaping, and often painting of the nails, removal of the cuticles, and massage of the hand or softening of the skin. Other nail treatments may include the application of artificial nail gels, tips, or acrylics, some of which are referred to as French manicures. Some manicures can also include the painting of pictures or designs on the nails or applying small decals or imitation jewels. When applied to the toenails and feet, this treatment is referred to as a pedicure.

A variety of tools are required to cut, shape, paint or otherwise care for or repair finger and toe nails including without limitation finger or toe nail nippers/scissors, cuticle nippers/scissors, nail clippers, tweezers, nail files, cuticle pushers, cuticle knives, nail cleaner, and hoof sticks. As a result, a manicure or pedicure set typically includes multiple tools, each of which can perform one or two of the functions necessary to perform a manicure or pedicure. Transporting or storing multiple tools for manicures and pedicures, such as when traveling, can therefore be awkward and cumbersome because of the plurality of tools required as well as the fact that they are typically elongated or very sharp tools that must be safely and carefully stored when not in use.

Combination, multi-function tools and tool kits are well known. In typical multi-function tools, a plurality of tools such as pliers, screwdrivers, knife blades, files, scissors and the like are provided in a single tool or unit The tools typically fold over and are received in channel-shaped handles or other types of housings in such tools. However, each of these technologies suffers from one or more of the following disadvantages:

1. the handle or other storage arrangement is usually not capable of containing or safely storing more than one or two tools or types of tools at a time;

2. the handle or handles are awkward to use or difficult to grip when a tool is in use;

3. the method of use can be somewhat slow or cumbersome in that, in order to deploy an individual tool, a series of steps is usually required (such as, for example, multi-function tool handle must first be opened, then an individual tool selected and opened, and the multi-function tool handles closed before the selected tool can be used); and

4. the size, arrangement or number of tools included in the combination tool or tool kit can make it difficult or impossible to use a particular tool.

These and other disadvantages in the currently available combination tool technologies can be particularly problematic with respect to fabricating a combination manicure or pedicure tool because of, for example, the size, dimensions, number, and sharpness of the tools required.

Thus there is a need in the hand and foot care industry for a combination manicure or pedicure set/kit having a sufficient number of tools that can be easily and quickly deployed for use, as well as means to safely store or transport the tools when they are not in use.

### BRIEF DESCRIPTION OF THE DRAWINGS

Further objects, features and advantages of the invention will become apparent from the detailed description, below, when read in conjunction with the accompanying drawings in which:

FIG. 1A is a left side perspective view of one specific, exemplary embodiment of the invention.

FIG. 1B is an exploded top, left side, perspective view of the embodiment illustrated in FIG. 1A showing the tools, pivots, compartments and other components on or within the housing;

FIG. 1C is an bottom, left side, perspective view of the embodiment illustrated in FIG. 1A showing the placement of tool, pivots, compartments and other components within the housing;

FIG. 2 is a top, perspective view of a nail clipper in accordance with one specific, exemplary embodiment of the invention;

FIG. 3 is a left side, perspective view of a push-push mechanism in accordance with one specific, exemplary embodiment of the invention;

FIG. 4 is a left side, sectional view of the embodiment illustrated in FIG. 1A showing the stacking of multiple tools within the housing; and

FIG. 5 is a top, left side, perspective view of one specific, exemplary embodiment of the invention showing one specific, exemplary configuration for using a cuticle nipper according to the invention.

### DETAILED DESCRIPTION

The following description is of a best mode presently contemplated for practicing the invention. This description is not to be taken in a limiting sense but is made merely for the purpose of describing the general principles of the invention whose scope may be ascertained by referring to the appended claims.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although a few suitable, exemplary devices processes or materials are described below, other devices, processes or materials similar or equivalent to those described herein can also be used in the practice or testing of the invention. All publications, patent applications, patents, and other references mentioned herein are incorporated by reference in their entirety. In case of conflict, the present specification, including definitions, will control. In addition, the devices, materials, processes, and examples disclosed herein are illustrative only and not intended to be limiting.

The following definitions refer to the particular embodiments described herein and are not to be taken as limiting; the invention includes equivalents for other undescribed embodiments.

As used herein, the term “kit” or “set” is intended to mean a plurality of articles or equipment needed for a specific purpose, including without limitation tools.

As used herein, the term “combination” is intended to mean a joining or merging of different parts or qualities in which the component elements are individually distinct, including without limitation tools.

As used herein, the term “tool” is intended to mean a handheld device or system that aids in accomplishing a task.

The invention disclosed herein includes without limitation combination multifunctional apparatuses and system as well as methods of use for same and, in particular, combination apparatuses, methods and systems for manicures and pedicures.

One aspect of the invention is a multi-function nail care tool that includes at least two hand tools suitable for nail care, including without limitation tools for cutting, shaping or painting nails. The tools can be housed in a retractable or folding housing or case that can substantially or completely cover the tools when the tools are not in use, such as when they need to be transported or stored. In one embodiment, the housing can be a flat oval shape on the bottom with a flat oval piece on the top that fits into the oval shaped bottom section, including without limitation as a click in device. In this embodiment, either the top or bottom side of the case could be opened to provide access to one or more tools. In another embodiment, an oval shaped case may be used where each oval shaped side of the case can be split into two halves, such one half of both sides of the cover open to provide access. In yet another embodiment, the housing can have a square box or other shape on the top for the click in device.

In another aspect, the housing may contain one or more internal compartments that may accommodate one or more tools that can be accessed by opening the housing. In one embodiment, the housing can include a first compartment for a tool that is integrated into the pivot mechanism used to open the housing. In another embodiment, the housing can include a second internal compartment for housing one or more tools including without limitation a cuticle pusher, a cuticle nipper and a nail file. In a further embodiment, the housing may include both such compartments. In yet another embodiment, one or more of the tools can be substantially or completely covered by the housing when not in use. In another embodiment, the housing may include one or more storage compartments on the outside of the housing.

In another aspect, the housing may contain one or more storage compartments that are external or which can provide external access to additional tools even when the housing is closed. In one embodiment, an external storage compartment can be integrated into the housing such that the compartment spans both sides of the housing, is shaped to accommodate a particular tool including without limitation a nail clipper, and can include an open, external portion or port providing ready access to the compartment whether the housing is open or closed. In another embodiment, the size, shape, or dimensions of the tool, storage compartment, housing or combination thereof can be modified in order to secure/anchor the tool to the housing when not in use. In yet another embodiment, the handle of the tool can be modified such that the tool can lock in place when stored.

In one non-limiting example of an external storage compartment, a tool and a portion of the housing or compartment therein can be fabricated such that, when the tool is placed in the housing or compartment, a tongue-in-groove member on the tool can connect with/engage a complementary tongue-in-groove member in the storage compartment or on the housing, such that the position of the tool in the housing or compartment can be temporarily secured. In one embodiment, a first surface on a handle on a tool and a second surface on a compartment in or on the housing can each be provided with complementary U-shaped grooves which, when the tool is seated in the compartment, are opposite each other, and also respective tongues immovably seated in or near the grooves in the first and second surfaces respectively, and projecting above the same so as to be capable of entering and of occupying the other groove in the opposite surface when the two surfaces are juxtaposed. Any suitable process of engagement can be employed to achieve this type of connection/engagement, including without limitation downward pressure on, sliding or extension of the tool. Any suitable mechanism or structure can be used to achieve the connection, including without limitation a pin-and-groove or tongue-and-groove mechanism or mechanism or structure. In a further embodiment, placement of a tool in the compartment, or removing it from the compartment, can be guided by a mechanism in the housing or compartment, including without limitation a pin and slide mechanism.

In another embodiment, the handle of the clippers may include one or more inverse ridge structures which can improve the grip of a user, including without limitation a human hand or mechanical gripping device or system. A ribbed or other type of raised surface on at least one portion of the top of the nail clipper handle can therefore be used to facilitate removal of the nail clipper tool as well as to enhance a user's grip when using the nail clippers as a stand-alone tool. That same surface, either alone or in combination with the housing, can also be used to improve the grip of a user when one of the other tools is in use or otherwise exposed, including without limitation cuticle nippers.

In one embodiment, the tool can be a nail clipper which can be released from an external storage compartment by performing one or more of the following actions. First pushing down on the handle of the clipper to disengage the connection between the tongue-in-groove member in the handle of the clipper and the complementary-shaped tongue-in-groove member in the housing/storage compartment that it locks into. One can then use a guide pin in the nail clipper to guide the clipper along a slide in the compartment until the pin meets a latch, notch or other suitable type of stop at the end of the slide, at which point one can optionally push down on the handle of the clipper a second time to fully release it from the housing. Pressure can be applied for this purpose using any suitable means, including without limitation one or more fingers or suitable mechanical means.

The nail clipper can later be replaced (put back into the combination tool) by reversing that process and thereby pushing the clipper far enough into the compartment to secure it such as, for example, by re-engaging the tongue-in-groove member on the tool with the complementary shaped tongue-in-groove member in the storage compartment located in the housing or, optionally, elsewhere in or on the housing.

In another embodiment, a port in the housing providing external access for an internal storage compartment can be covered. The storage compartment can be positioned within the housing and accessed via a tab or button at one end of the compartment, for example, a tab or button that can be accessible from the exterior surface of the housing, and which can effectively seal the compartment off from the exterior of the housing. Any suitable mechanism can be used to provide access to this type of compartment, including without limitation a spring-loaded push button mechanism. The surface of the external cover or button can be fabricated in any suitable shape or dimensions, including without limitation a cover or button that is flat or shaped to accommodate the human finger or hand, so as to be easily depressed or pushed.

There are several ways the combination tool can be used depending upon which instrument or hand tool contained in the housing is chosen and how that tool is accessed or used; several non-limiting examples of use and of apparatuses and systems according to the invention are included herein as Examples.

### Example 1

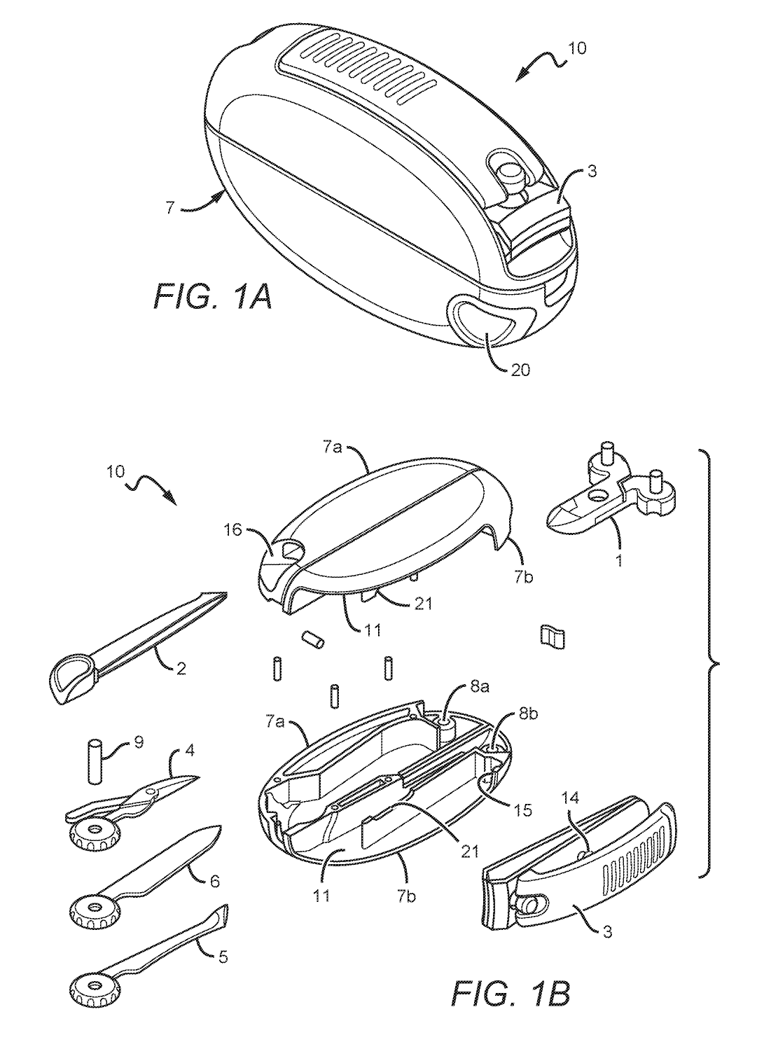

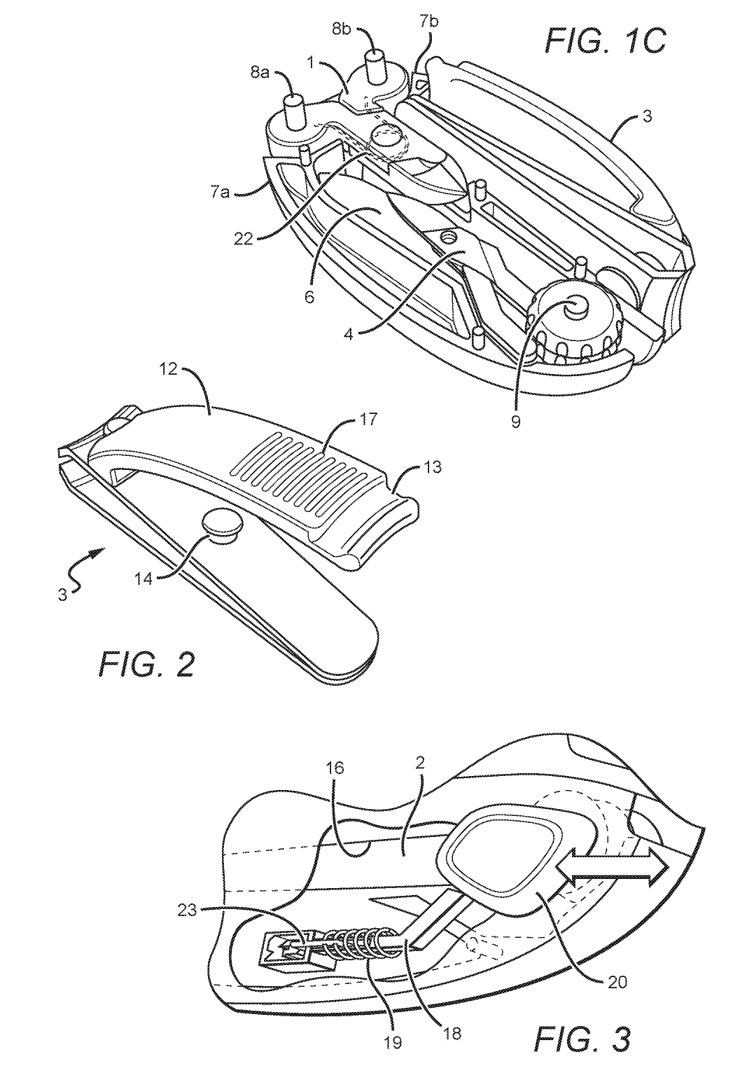

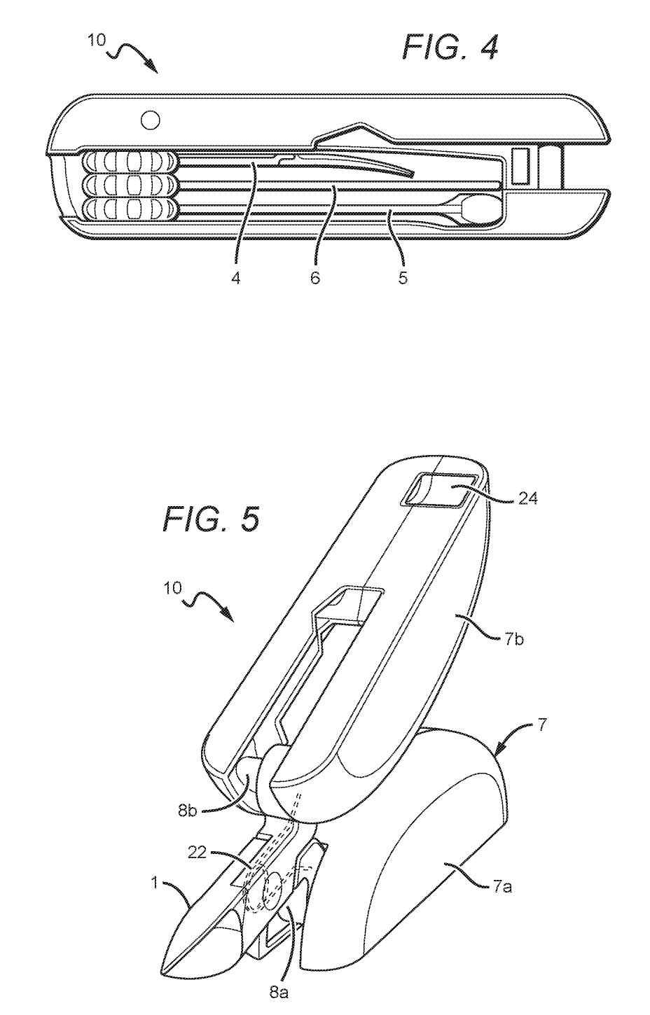

One embodiment of the invention is the Nail Anywhere Kit (NAK™) illustrated in FIGS. 1-5; The NAK™ is a portable, sleek all-in-one nail care kit 10 containing a housing 7 and one each of the following tools in a two part housing: cuticle nippers 1, tweezers 2, nail clippers 3, cuticle scissors 4, a cuticle pusher 5 and a nail file 6 as illustrated in FIG. 1B-C and FIG. 4. Two parts of the housing 7a, 7b can be pivotally connected to the handles of the cuticle nippers 1 as illustrated in FIGS. 1B-C.

The nippers 1 can be deployed by rotating the two parts of the housing 7a, 7b around their respective pivots 8a, 8b such that the cuticle nippers 1 are exposed; the two parts of the open housing 7a, 7b can also be used as handles to grip the tool as illustrated in FIG. 5. The cuticle scissors 4, cuticle pusher 5 and nail file 6 are pivotally connected to a different pivot 9 located within the housing 7 such that they each can be deployed by opening one part or both parts of the housing, 7a and 7b respectively and, when not in use, be safely stored within the housing 7 as illustrated in FIG. 1C and FIG. 4. The storage compartment 24 housing the cuticle scissors 4, cuticle pusher 5 and nail file 6 can be located in or span both the first and second halves 7a and 7b of the housing. The housing can be a hard or soft shell cover in this embodiment. The axes of the first pivot and the second pivot can extend transversely through at least one portion of the cuticle nippers 1. The axes of the first pivot and the second pivot can be at right angles to the axis of the first part and the second part of the housing.

The nail clippers 3 in this embodiment are located in a storage compartment 11 accessible from the outside of the housing. The storage compartment spans both parts of the housing 7a and 7b at one end of the tool, and the nail clippers can manually be removed from or placed into this compartment when the housing is open or closed. A recessed groove in a tongue-in-groove member 13 at one end of the handle 12 of the nail clippers 3 can, when used in conjunction with a complementary shaped tongue-in-groove member 15 in the storage compartment 11, be used to temporarily secure the nail clipper 3 to the storage compartment 11 in the housing 7 when not in use. Injection or ejection of the clipper 3 from the storage compartment 11 in the housing 7 can be aided by a pin-and-slide mechanism using a guide pin member 14 on the nail clipper 3 and a slide member 21 in the storage compartment 11.

The tweezers 2 in this embodiment are located in another storage compartment 16 accessible from the outside of the housing 7 via a cap or cover 20 as illustrated in FIG. 3. The tweezers 2 in that storage compartment 16 can be manually removed from or placed into the compartment 16 when the housing is either open or closed; removal can be facilitated by using a suitable mechanism, including without limitation a spring-loaded, push-push mechanism. The tweezers can therefore have a pop in and pop out (push-push) device in them to secure the tweezers from falling out. Push it once for example, and it pops out, then push it a second time to click back into the hard shell/cover (housing) of the embodiment.

The nail file 6, cuticle pusher 4 and cuticle scissors 4 are all located in another compartment and connected at a single pivot point in this embodiment; these tools can thus flip out and lock into place when they are horizontal for easy use and any suitable locking mechanism can be used for this purpose, including without limitation locking mechanisms on or in the housing. The size, dimensions and shape of the housing 7 can be chosen to fit the natural contours of a gripping member, including without limitation a human hand, such that the housing 7 can be used to enhance the grip of a subject when using these tools; and that grip, as well as the ability to manipulate the tool, can be further enhanced by the presence of suitably textured surfaces on the housing such as the inverse ribbing 17 on the nail clippers 3 illustrated in FIG. 1B and FIG. 2.

In this embodiment, the order of hand tools laid out from right to left, as illustrated in FIGS. 1B-1C, can be:

1. left half of cover (opening at front/top) 7a;

2. nail clippers 3;

3. cuticle nippers 1;

4. tweezers 4; and

5. right half of cover (opening at front/top) 7b

and the order of hand tools laid out from top to bottom can be:

6. cuticle scissors 4;

7. nail file 6; and

8. cuticle pusher 5.

### Example 2

The nail clipper 3 illustrated in FIGS. 1B-2 can slide in and out of the housing 7 along a slide member 21 in the storage compartment 11 and, after sliding into the storage compartment 11, can lock into place using a curved, U-shaped groove 13 at the tip of the handle 12. The sliding motion can be facilitated by a pin 14 on the nail clipper and a slide 21 in the storage compartment 11. The curved U-shaped groove in the tongue-in-groove member 13 at the back end of the nail clipper handle 12, where one's fingers usually go when the tool is in use, can interact with a complementary U-shaped groove in the tongue-in-groove member 15 in the storage compartment 11 in the housing 7 such that the tool can be locked into place by pushing down on the nail clipper 3, positioning the tongue-in-groove member 13 on the nail clipper 3 underneath the tongue-in-groove member 15 in the housing 7, and then releasing the pressure on the clipper 3, thereby allowing the complimentary shaped tongue-in-groove member 13 on the clipper 3 and the complementary tong-in-groove member 15 in the storage compartment 11 to juxtapose or otherwise come into contact and engage. The inherently springy nature of a nail clipper 3 that facilitates this process arises when two or more metal parts are stamped together during fabrication of the tool.

The nail clipper 3 in this embodiment can be released from the storage compartment 11 by pushing down on the handle 12 of the clipper 3 to disengage the connection between the tongue-in-groove member 13 in the handle 12 of the clipper 3 and the complementary-shaped tongue-in-groove member 15 in the storage compartment 11 in the housing 7 that it locks into. One can then use the pin 14 in the nail clipper 3 to guide the clipper 3 along the slide 21 in the storage compartment 11 until the pin 14 meets a latch, notch or other suitable type of stop at the end of the slide 21, at which point one can push down on the handle 12 of the clipper 3 a second time to fully release it from the storage compartment 11 in the housing 7.

### Example 3

The housing 7 illustrated in FIG. 1 can be opened by taking the two oval housing pieces 7a and 7b and unfolding them to expose the cuticle nippers 1 inside. Placing ones hands on both sides of the oval shaped members in the housing 7a and 7b, one can then, with one hand, bring the two housing pieces 7a and 7b close together in order to connect them and thereby form a configuration like a pair of scissors, as illustrated in FIG. 5. Using this method, the cuticle nippers 1 can fold at two pivot points and lock into place when they are facing out, such that one is better able to use them. The shape of the housing 7 and the spring 22 inside the cuticle nippers 1, when configured correctly, can further enhance the strength or durability of the locked tool. The circular ends of the cuticle nippers having the pivot points 8a and 8b, for example, can be fanned out to prevent the two sides of the housing 7a and 7b from pressing into each other. The shape of one or both of the half ovals 7a and 7b in the housing 7 behind the cuticle nippers can, when configured correctly, also stop the cuticle nippers 1 from extending too far, which can further enhance the strength and durability of the tool.

### Example 4

To use the tweezers 2, one can use a push-push mechanism to remove them from their compartment 16 and then secure them in place again when done using the same mechanism. In this embodiment, a push-push mechanism can be included in the housing 7 as illustrated in FIG. 3. In one embodiment, a push-push mechanism can include an angled rod 18, a spring 19, and a button 20. The rod 18 can be spring-loaded or otherwise coupled to the spring 19 and the button 20 in order to facilitate injection and ejection of the tool. The push-push mechanism illustrated in FIG. 3 uses a diagonal rod 18 in order to be able to fit into the tweezers compartment 16 such that the tweezers 2 do not slip; this type of rod configuration can also help lock the spring 19 because the rod 18 is in the side compartment 16 holding the tweezers 2. The spring 19 and rod 18 are preferably small enough to fit into the compartment 16 on one side of the tweezers 2. The spring 19 can have a pin 23 connected to it such that, when pressure is applied to the diagonal rod 18, the spring can push the pin 23 down, thereby locking the tweezers into place. To use the tweezers 2, one can click on a button, box or other equivalent component 20 on top of the housing and it can pop out ready for use. Alternatively, a more typical spring-loaded mechanism can be used. In one embodiment, the angle of the rod can range from 90 to 180 degrees. In another embodiment, the angle of the rod can range from 90 to 120 degrees. In yet another embodiment, the angle of the rod can range from 110 to 150 degrees.

### Example 5

For the other tools contained in the housing 7, including without limitation the cuticle scissors 4, nail file 5, and cuticle pusher 6 illustrated in FIG. 1B and FIG. 4, one can open the housing 7, locate the tool one wants to use and then rotate it about the pivot connecting the tool to the housing 7 in order to provide an optimal position for use. The housing 7 can then be closed before use in order to enhance a subject's/user's grip when the tool is being used. These tools can thus flip out and lock into place when they are horizontal for easy use; any suitable locking mechanism can be used for this purpose, including without limitation locking mechanisms on or in the housing or the tool. Any suitable gripping device can be used for this purpose, including without limitation a hand or mechanical gripping device.

### Example 6

In one embodiment, an apparatus according to the invention can be fabricated by drilling holes in the bottom and top of at least one tool, including without limitation hand tools such as cuticle nippers 1, tweezers 2, nail clippers 3, cuticle scissors 4, a cuticle pusher 5, and a nail file 6. One can also take two molded housing members 7a and 7b, each of which can form a half oval shape, and drill holes in the bottom and top of each member at or near a pivot point 9. A hole in the first housing member 7a can then be aligned with a hole in a first tool including without limitation cuticle scissors 4 and adding tools sequentially in the desired order, including without limitation, a cuticle pusher 5 and a nail file 6. The tools can thereby be placed where one wants or needs them, or as dictated by the size, shape or dimensions of the tool or tools desired, by aligning the holes in the first housing member with the hole in the bottom of each tool as it is added as illustrated in FIG. 1C. After the last tool is added, one can align a hole in the second housing member 7b with a hole in the last tool added, thereby forming a housing which can substantially envelope or otherwise cover the tools. One can also place a small rod 9 in the holes connecting the two half oval housing members to those tools and to each other, thereby securing the position of the stacked tools at a single pivot point, with respect to each other and to the housing. In some embodiments, there can be one or more additional single or multi-tool compartments with ports on the exterior of the housing, including without limitation compartments for tweezers or nail clippers.

The embodiments described herein can provide one or more of the following improvements: a combination tool; easy access to each tool; a sufficient number of tools available for most nail care needs; a housing for safe or convenient storage and transport of the tools; and a housing that can improve a user's grip when using a tool. In addition, one of the combination tool's most exceptional characteristics lies in its ability to provide all the tools needed for most, if not all, nail care needs integrated into a compact, safe, easy to use and aesthetically pleasing storage compartment for containment or transport when the tools are not in use.

Any suitable size, shape or dimensions can be used for the housing. Materials suitable for the housing include without limitation plastic, stainless steel or rubber.

Any suitable type or combination of tools can be used for the invention including without limitation cuticle nippers, tweezers, nail clippers, cuticle scissors, a cuticle pusher and a nail file. Materials suitable for the hand tools include without limitation plastic, high grade stainless steel or rubber. One non-limiting example of a nail file suitable for the invention is an Emeryl file.

Materials suitable for connecting the tools to each other include without limitation plastic, stainless steel or rubber.

Any suitable mechanism can be used to inject tools into or eject tools from the housing, including without limitation slide and pin mechanisms, spring-loaded mechanisms and push-push mechanisms.

Any suitable mechanism can be used to secure a tool to the housing, including without limitation a spring-loaded push-push or push-pull mechanism. Materials suitable for connecting the housing to the tools include without limitation plastic, stainless steel or rubber.

The combination nail care tool described above is only one exemplary embodiment of the invention which also may have uses in other applications including without limitation any applications that may benefit from a combination tool for personal or professional use. The advantages of the invention include without limitation; multi-functionality in a single, safe and aesthetically pleasing package, as well as portability.

While several illustrative embodiments of the invention have been disclosed herein, still further variations and alternative embodiments will occur to those skilled in the art. The number, types or order of the hand tools or instruments in the combination nail care tool, for example, can vary according to the needs or desires of a particular user or group of users, as can the size and dimensions of the tools and the manner in which they are combined, including without limitation the use of foldable or stackable tools. Such variations and alternative embodiments are contemplated, and can be made without departing from the spirit and scope of the invention as defined in the appended claims.

We claim:

1. A combination tool apparatus comprising a housing and at least two tools wherein:
the housing comprises a first part and a second part and is effective to substantially contain the at least two tools;
the first part and the second part of the housing are pivotally connected to a first pivot and a second pivot, respectively, wherein the first pivot and the second pivot are enclosed by the housing; and
at least one first tool is integrated into the first pivot and the second pivot.

2. The apparatus of claim 1, wherein at least one second tool is pivotally connected to a third pivot and the third pivot is enclosed by the housing.

3. The apparatus of claim 1, wherein the at least one first tool is a cuticle nippers and the first and second pivots are located on or adjacent to a first handle and a second handle of the nippers, respectively.

4. The apparatus of claim 1, wherein the housing comprises at least one storage compartment, and at least one portion of the at least one storage compartment is located on the exterior of the housing.

5. The apparatus of claim 4, wherein the housing comprises a first storage compartment having a shape or dimensions effective to contain a tool, at least one first portion of the first storage compartment is located in the first part of the housing, at least one second portion of the first storage compartment is located in the second part of the housing, and the storage compartment is located on the exterior of the housing.

6. The apparatus of claim 5, wherein at least one portion of the first storage compartment comprises a first structural member, at least one portion of the tool comprises a second structural member, and the first member and the second member are effective to secure the tool to the housing or guide the tool into or out of the first storage compartment.

7. The apparatus of claim 6, wherein the first structural member is a slide member and the second structural member is a pin member.

8. The apparatus of claim 6, wherein the first structural member is a first tongue-in-groove member, the second structural member is a second tongue-in-groove member, and the shapes of the first and second tongue-in-groove members are complimentary.

9. The apparatus of claim 6, wherein the tool is a nail clipper.

10. The apparatus of claim 1, wherein the housing comprises a second storage compartment having a shape or dimensions effective to contain a tool, the second storage compartment is substantially located within the first part or the second part of the housing, and the second storage compartment comprises a port located on the exterior of the housing.

11. The apparatus of claim 10, wherein the tool is a tweezers.

12. The apparatus of claim 10, further comprising a mechanism effective to substantially inject a tool into, or substantially eject a tool out of, the second storage compartment.

13. The apparatus of claim 12, wherein the mechanism is a spring-loaded mechanism.

14. The apparatus of claim 13, wherein spring-loaded mechanism is a push-push mechanism comprising a spring and a rod, and the shape or dimensions of the rod comprises at least one angle.

15. The apparatus of claim 1, wherein the shape of the apparatus is substantially oval or round, and effective to enhance a subject's ability to grip or manipulate at least one of the at least two tools.

16. The apparatus of claim 1, wherein the apparatus is a manicure kit, a pedicure kit or combination thereof.

17. A system comprising the apparatus of claim 1.

18. The system of claim 17, wherein the system is effective to improve the appearance or health of a hand, a fingernail, a foot, a toenail or a combination thereof.

19. A method for procuring one or more tools from a combination tool apparatus, the method comprising:
providing an apparatus according to claim 7, wherein the first storage compartment comprises a tool, a slide member and a first tongue-in-groove member, the tool comprises a pin member and a second tongue-in-groove member having a shape complementary to the first tongue-in-groove member, and the first tongue-in-groove member is adjacent to and engaged with the second tongue-in-groove member;
Applying a first pressure to the tool, thereby disengaging the first and second tongue-in-groove members; and
sliding the tool away from the storage compartment by guiding the pin member in the tool along the slide member in the compartment.

20. The method of claim 19, further comprising applying a second pressure to the tool, thereby releasing the tool from the housing.

21. A combination tool apparatus comprising a housing and at least two tools wherein:
the housing comprises a first part and a second part and is effective to substantially contain the at least two tools;
the first part and the second part of the housing are pivotally connected to a first pivot and a second pivot, respectively, wherein the first pivot and the second pivot are enclosed by the housing;
at least one first tool is integrated into the first pivot and the second pivot; and
the housing comprises at least one storage compartment, wherein at least one portion of the at least one storage compartment is located on the exterior of the housing.

22. A combination tool apparatus according to claim 21, wherein the shape of the apparatus is substantially oval or round, and effective to enhance a subject's ability to grip or manipulate at least one of the at least two tools.
